(19) United States
(12) Patent Application Publication
(10) Pub. No.: US 2004/0236675 A1
(43) Pub. Date: Nov. 25, 2004

(54) Aggregation of credit facilities

(76) Inventors: David Rolf Lynch, Brighton (AU); Andrew Gale, Wahroonga (AU); David Roger Eastwood, Elizabeth Bay (AU)

Correspondence Address: Brinks Hofer, Gilson & Lione, PO Box 10395, Chicago, IL, 60610, US

(21) Appl. No.: 10/467,737

(22) PCT Filed: Feb. 12, 2002
(86) PCT No.: PCT/AU02/00140

(30) Foreign Application Priority Data
Feb. 12, 2001 (AU) PR 3031

(51) Int. Cl. G06F 17/60

(52) U.S. Cl. 705/38

(57) ABSTRACT

The present invention provides a method of credit aggregation in an arrangement including a borrower, a plurality of credit suppliers, and a credit aggregator, the method including the steps of: determining a borrower's credit requirements; assessing offers of credit from the credit suppliers to determine a suitable combination of credit offers to meet the needs of the borrower; the credit aggregator entering into at least one agreement with the borrower to provide the suitable combination of offers; the credit aggregator entering into separate agreements with each of the credit suppliers in relation to the relevant parts of each offer to supply credit to the borrower; wherein the arrangement of credit facilities are supplied by the credit suppliers to the borrower without the borrower entering into an agreement with the individual credit suppliers.

### FIELD OF THE INVENTION

This invention relates generally to a method and system for supplying credit to a borrower. In particular, the invention is well suited to the aggregation of credit supplies to enable a borrower to configure a credit arrangement to suit their requirements.

### BACKGROUND OF THE INVENTION

A borrower seeking credit will generally compare the terms and conditions of credit facilities offered by alternative credit suppliers in order to determine the facility most appropriate to their requirements. Where a borrower has only one asset to offer as security, most credit suppliers will generally only offer credit on attractive terms if they are able to register a first ranking security interest in respect of that asset. Consequently, a borrower with only a single asset to offer as security is limited to dealing with one credit supplier, notwithstanding that their requirements may be better satisfied by simultaneously establishing credit facilities with multiple credit suppliers.

In contrast, merchant credit arrangements may include credit supplied by a range of credit suppliers with one supplier establishing an agreement with a merchant whilst establishing numerous agreements with other credit suppliers. However, merchant credit arrangements are generally not restricted by provision of security in the form of a single asset and the terms and conditions are usually negotiated and specifically tailored for each particular arrangement. In this respect, credit is not usually assessed using standard statistical methods.

Even though a borrower may be restricted to securing credit with a single asset, the credit requirements of a borrower will generally change over time and in many instances the borrower's existing credit supplier may not offer, or continue to offer, the best means of satisfying those changed requirements. However, in practice, the cost and inconvenience of changing credit supplier will often deny the borrower the option of securing credit from an alternative credit supplier that may better suit the borrower's present and/or future requirements.

An intermediary such as a finance broker or a financial planner will often assist a borrower in identifying and negotiating credit facilities that satisfy the borrower's requirements. However, similar to the borrower acting independently, the intermediary and borrower are generally limited to obtaining funds from only a single credit supplier.

An intermediary will also often monitor a borrower's changing requirements and the suitability of current and alternative credit arrangements. However, the benefits associated with changing to an alternative credit supplier must be weighed against the cost of making such a change. Usually, the cost of this type of change is relatively high and exceeds any incremental benefit for the borrower. As such, the intermediary is limited to renegotiating credit arrangements with the borrower's existing supplier of credit.

As a result, a problem exists for borrowers restricted to securing credit with a small number of assets where, in order to obtain the best available terms and conditions, each potential credit supplier insists upon a first ranked mortgage over the assets.

Some intermediaries consider the inherent restrictions with respect to negotiating credit facilities to unduly limit their ability to offer additional value to a borrower and hence choose not to provide advice in respect of a borrower's credit arrangements. This is in stark contrast to financial advice that is usually supplied in relation to investments where intermediaries are not confronted with similar constraints.

Of course a borrower with a single asset available for security could seek to negotiate an arrangement with multiple credit suppliers thus initiating a syndicated credit arrangement. However, as the terms and conditions of these arrangements are usually individually negotiated for each arrangement, this would incur a significant cost which would detract from the borrower's attempt to secure credit at least cost.

Accordingly, it is an object of the present invention to provide a means and method of providing credit to a borrower from a plurality of credit suppliers which reduces complexity, and hence the cost, of establishing and monitoring such arrangements. Where complexity and cost can be significantly reduced, it is feasible for syndicated style credit arrangements used in commerce to become cost effective for consumer credit arrangements.

It is a secondary object of the present invention to provide such a means and method that reduces the complexity and cost of reconfiguring the supply of credit from credit suppliers to a borrower.

### SUMMARY OF THE INVENTION

In one aspect, the present invention provides a method of providing credit to a borrower wherein a credit aggregator provides that credit to a borrower up to a first limit in accordance with at least one credit agreement between the borrower and the aggregator, the aggregator sourcing that credit in accordance with separate agreements between the aggregator and at least one credit supplier.

Preferably, the at least one credit agreement solely consists of one or more agreements between the borrower and the aggregator and/or intermediaries acting for the borrower or aggregator. Additionally, it is also preferred that the separate agreements solely consist of agreements between the aggregator and the at least one credit supplier and/or any intermediaries acting for the aggregator or credit supplier. Of course, a credit supplier may also act as a credit aggregator and is considered as a credit aggregator when acting in that capacity.

In any event, the agreements do not include any direct agreement between the borrower and the at least one credit supplier.

Credit is provided to a borrower up to a first limit which represents the total borrowing capacity of the borrower as agreed between the various parties. Initially, the first limit may be proposed by the borrower, or an advisor acting for the borrower. The credit aggregator may receive the proposed first limit and may accept or reject the proposed first limit based upon any assessment made by the credit aggregator. Additionally, it is conceivable that the credit aggregator may initially accept a proposed first limit but subsequently inform the borrower that the first limit is rejected by credit suppliers.

In any event, the first limit that is eventually embodied in a credit agreement between the credit aggregator and the borrower is a total borrowing capacity for the borrower that is agreed between the various parties involved in providing credit to the borrower.

Preferably there is only a single credit agreement between the borrower and the credit aggregator for the purposes of providing credit to the borrower up to the first limit, and it is particularly preferred that the first limit be segmented with each segment having a segment limit in accordance with terms agreed between the credit aggregator and individual credit suppliers from whom credit is provided.

It is preferred that, with respect to individual credit suppliers, the credit aggregator pass borrower's payments to the credit supplier and provide credit from the credit supplier for the purpose of funding payments to the borrower. Preferably, the credit aggregator holds any security provided by the borrower associated with securing the first limit not on its own account but for the benefit of the credit supplier. Preferably, the security is not exclusive for any particular credit supplier.

Any credit agreement between the credit aggregator and the borrower preferably includes any agreed terms between the credit aggregator and each credit supplier in respect of credit supplied by that credit supplier.

In a preferred embodiment, the credit aggregator may vary the credit agreement with a borrower without establishing a new credit agreement. Preferably, such variations avoid the need for a new credit agreement and may include variations to the terms agreed between the credit aggregator and individual credit suppliers. Any variation to the terms for any individual credit agreement may include a variation to a segment limit relating to credit provided from a credit supplier. Preferably, the credit aggregator is able to establish new agreements with new and/or existing credit suppliers and offer new credit arrangements to prospective or existing borrowers in accordance with terms associated with those new agreements.

In a preferred embodiment, upon offering a new credit arrangement to an existing borrower, the credit arrangement may be accepted by the borrower and the agreement between the borrower and the aggregator may be varied to reflect the terms and conditions of the new credit arrangement.

In an embodiment of the invention, the borrower is able to determine the segmentation of their credit requirement up to the first limit with regard to terms previously agreed between the credit aggregator and individual credit suppliers from whom credit is provided. In this embodiment, a borrower is able to vary the segmentation of their credit requirement to suit any changes in circumstance that may arise subsequent to establishing their previous segmentation without the burden of establishing a new credit agreement with the credit aggregator. Additionally, as new terms of credit supply are agreed between credit suppliers and the credit aggregator, the borrower is able to vary their segmentation to take best advantage of any new terms of credit supply, again without the burden of establishing a new credit agreement with the credit aggregator.

In a preferred embodiment, a credit aggregator is able to present a range of segmentations to prospective or existing borrowers that may be altered over time in accordance with changes to the borrower's credit requirements and capacity.

Once a credit segmentation is established for a borrower, and a credit agreement is established between the borrower and the credit aggregator, the credit aggregator may administer the cash flows relating to that credit agreement as if the credit agreement was directly between the borrower and the relevant credit providers.

The credit aggregator may extract a commission from the borrower and/or credit suppliers as payment for their services in managing and administering the individual agreements with credit suppliers and the credit agreement with the borrower. The credit aggregator may alternatively, or additionally charge a borrower a particular interest rate and pay a credit supplier at a different rate of interest and/or at different intervals.

It is also preferred that the credit aggregator pass to individual credit suppliers the credit and liquidity risks associated with the relevant segment limits for the credit agreements between the borrower and the credit aggregator. In other words, once each credit segmentation is established, the credit aggregator is not a party to the credit risk, and holds the security on behalf of the various credit suppliers. In a practical implementation, the entity holding the collateral may be different to the entity which enters into the agreements with the borrowers and the credit suppliers.

Preferably, in the event of default on the part of the borrower, the credit suppliers may be appointed as agents of the credit aggregator in order to recover any outstanding debts from the borrower, or otherwise are able to enforce any security interests against the borrower.

Of course, the credit aggregator may enter into additional credit agreements with new or existing borrowers and may provide credit to those borrowers without the need for entering into additional credit agreements with credit suppliers. In practice, it is possible that credit aggregators would establish “standing” agreements for a range of credit offerings with a range of credit suppliers prior to making offers to borrowers. These “standing” agreements with credit suppliers would provide a credit aggregator with flexibility to propose combinations of credit offerings to a borrower based upon the current credit requirements of the borrower. Of course, over time, the credit aggregator could establish new “standing” agreements with new or existing credit suppliers.

It will be appreciated that the precise legal relationships may vary depending upon the prevailing laws for any particular jurisdiction. However, the general principle of the present invention is to separate the relationships so that the borrower does not directly contract with the various credit suppliers whilst retaining an ability for the credit suppliers to recover funds if necessary from the borrower.

In another aspect, the present invention provides a method, administered by means of a computer communications network, of providing credit to a borrower wherein a credit aggregator provides that credit to a borrower up to a first limit in accordance with at least one credit agreement between the borrower and the aggregator, the aggregator sourcing that credit in accordance with separate agreements between the aggregator and at least one credit supplier.

In another aspect, the present invention provides a system for providing credit to a prospective borrower wherein a credit aggregator agrees terms with at least one credit supplier and offers credit to borrowers up to a first limit in accordance with those terms, the credit aggregator establishing at least one credit agreement with the borrower for the purpose of providing credit to the borrower and at least one credit supply agreement with the at least one credit supplier from whom credit is obtained, the system including:

means for the credit aggregator and credit suppliers to agree terms relating to the supply of credit;

means for a prospective borrower to provide details of their credit requirements to the credit aggregator;

means for the credit aggregator to facilitate the prospective borrower selecting from a range of credit offers to suit their credit requirements, the resulting selection forming a credit segmentation satisfying their credit requirements;

means for the credit aggregator to forward details of prospective borrowers to credit suppliers;

means for the credit aggregator to administer cash flows relating to a borrowers' credit agreement with the credit aggregator and means for the credit aggregator to administer cash flows relating to credit supply agreements between the credit aggregator and the at least one credit supplier.

Preferably, the system also enables existing borrowers to advise their credit requirements, which may result from changed circumstances, and to establish an alternative segmentation as compared with their existing segmentation at that time.

In a preferred embodiment, the borrower, credit aggregator and credit suppliers each have access to a computer system which is operably connected to a data communications network to effect communication between each of the borrower's, credit aggregator's and credit suppliers' computer systems. In this instance, the individual computer systems and data communication network act as the means for transferring information between each of the parties.

In a particularly preferred embodiment, the data communications network comprises the internet and details of terms of credit supply and/or risk assessment details may be communicated by way of electronic mail or directly entered into a relevant website for subsequent processing. In other embodiments, communication between the borrower, credit aggregator and credit suppliers is effected by use of instant messaging facilities provided by a telecommunications service provider. One current example of this type of messaging is the Short Message Service (SMS) facility presently supported by various telecommunication service providers.

According to yet another aspect, the present invention provides a method of credit aggregation in an arrangement including a borrower, a plurality of credit suppliers, and a credit aggregator, the method including the steps of:

determining a borrower's credit requirements;

assessing offers of credit from the credit suppliers to determine a suitable combination of credit offers to meet the needs of the borrower;

the credit aggregator entering into at least one agreement with the borrower to provide the suitable combination of offers;

the credit aggregator entering into separate agreements with each of the credit suppliers in relation to the relevant parts of each offer to supply credit to the borrower;

wherein the arrangement of credit facilities are supplied by the credit suppliers to the borrower without the borrower entering into an agreement with the individual credit suppliers.

Of course, the credit aggregator may establish a range of “standing” agreements with various credit suppliers prior to assessing the most appropriate combination of credit offers for a borrower.

In another aspect, the present invention provides A method of credit aggregation in an arrangement including a borrower, a plurality of credit suppliers, and a credit aggregator, the method including the following steps in any order:

the credit aggregator entering into separate agreements with each of the credit suppliers for the supply of credit in accordance with offers of credit from the credit suppliers;

determining a borrower's credit requirements;

assessing offers of credit from the credit suppliers to determine a suitable combination of credit offers to meet the needs of the borrower;

the method subsequently including the following steps of:

the credit aggregator entering into at least one agreement with the borrower to provide the suitable combination of offers, the relevant part of the combination of offers being subject of the relevant separate agreement with a credit supplier;

wherein the arrangement of credit facilities are supplied by the credit suppliers to the borrower without the borrower entering into an agreement with the individual credit suppliers.

In another aspect, the present invention provides A method of credit aggregation in an arrangement including a borrower, a plurality of credit suppliers and a credit aggregator the method including the steps of:

determining a borrowers credit requirements;

providing the borrower with a plurality of credit offers enabling borrowers to segment their total credit requirement amongst offers;

the credit aggregator assessing the borrowers credit capacity and performing a valuation of any security proposed by the borrower, said valuation being in accordance with procedures acceptable to credit suppliers, and submitting a request to the relevant credit suppliers whose offers are included in the segments of the borrowers total credit requirement;

the relevant credit suppliers conducting a credit risk assessment of the borrower;

in the event that the relevant credit suppliers accept the borrowers request the credit aggregator enters into separate agreements with the relevant credit suppliers to provide credit to the borrower;

the credit aggregator assembling credit terms and conditions of relevant credit suppliers and establishing at least one credit agreement with the borrower;

wherein credit is provided to the borrower by the credit aggregator without the borrower entering into an agreement with the individual relevant credit suppliers and where the credit aggregator passes to the individual relevant credit suppliers and where the credit aggregator passes to the individual relevant credit suppliers the credit and liquidity risk associated with the respective credit limits of the credit suppliers and enabling borrowers the ability to reconfigure the segments of their credit arrangement without establishing a new agreement between the borrower and the credit aggregator.

In another aspect, the present invention provides A system for credit aggregation in an arrangement including a borrower, a plurality of credit suppliers and a credit aggregator, the system including:

a data communication network and communication devices enabling communication between the borrower, credit aggregator and the plurality of credit suppliers.

a web-site enabling a borrower to segment their total credit requirements amongst various credit suppliers and to provide personal details and details of any security to a credit aggregator;

a first computing means operably connected to the data communications network to receive information from the web-site and operable to assess the borrowing capacity of the borrower and the value of the security offered by the borrower based upon information obtained from the web-site;

a second computing means operably connected to the data communications network to receive information from the web-site and other sources and operable to assess the credit risk of the borrower;

wherein, in the event that a borrowers request for credit is accepted, the credit aggregator enters into at least one credit agreement with the borrower and separate agreements with the credit suppliers where the credit aggregator passes to the individual credit suppliers the credit and liquidity risk associated with the credit provided by the credit suppliers.

In the instance that cash flows associated with credit agreements between borrowers and the credit aggregator are passed from the credit aggregator to credit suppliers, and any security associated with these credit agreements is held not on its own account but for the benefit of credit suppliers, relevant assets in the accounts of the credit suppliers, being advances to the credit aggregator, may be granted by relevant Statutory Regulatory Authorities concessions with respect to the weighting of assets for the purpose of determining capital adequacy. Additionally, in the instance that the credit and liquidity risks associated with the credit agreements between the borrowers and the credit aggregator are passed from the credit aggregator to credit suppliers, the credit aggregator may be granted by the relevant Statutory Regulatory Authorities concessions with respect to the maintenance of minimum levels of capital. In Australia, the current relevant authority is the Australian Prudential Regulatory Authority.

A system and method according to the present invention embodies a number of advantages including increased flexibility for borrowers to establish and alter their credit segmentation according to their changing requirements and capacity and/or to take advantage of changing market conditions in relation to the supply of credit.

### BRIEF DESCRIPTION OF THE DRAWINGS

One embodiment of the invention will now be described with reference to the accompanying drawings in which:

FIG. 1 is a block diagram illustrating relationships between a borrower (B), a credit aggregator (CA) and various credit suppliers (CS₁, CS₂ and CS₃);

FIGS. 2a and 2b are block diagrams depicting a series of method steps for originating a supply of credit to a prospective borrower who may be assisted by an adviser, the block diagrams being arranged to represent the separate roles of the borrower/adviser, the credit aggregator and credit suppliers;

FIGS. 3a and 3b are block diagrams depicting a series of method steps for varying the supply of credit to a borrower who may be assisted by an adviser;

FIG. 4 is a block diagram depicting method steps for a customer-initiated drawdown and/or additional repayment of principal;

FIG. 5 is a block diagram depicting method steps for arranging scheduled principal repayments, interest charges or other charges initiated by a credit supplier;

FIG. 6 is a block diagram depicting method steps in the instance of a borrower or adviser demanding information from a credit aggregator;

FIG. 7 is a block diagram depicting the steps of a method of periodic reconciliation between the credit aggregator and credit suppliers; and

FIGS. 8a and 8b are block diagrams depicting the steps of a method of credit suppliers initiating recovery of funds upon detection of a default.

### DESCRIPTION OF A PREFERRED EMBODIMENT

The following provides a detailed description of a method according to the present invention. In the following description, certain tasks and functions are distributed amongst three parties, namely, the “borrower/adviser”, the “credit aggregator” and the “credit suppliers”. The particular embodiment described and detailed in the accompanying Figures represents one example of the distribution of various tasks and functions amongst the parties involved. However, it will be recognised by those skilled in the art that the distribution of tasks and functions may vary depending upon specific circumstances that apply. For example, the precise legal relationships between the various parties may vary depending upon the prevailing laws for particular jurisdictions. As such, the distribution of tasks in the following description may be suitable for some countries but not practical or acceptable for others. Where some functions are performed by the credit supplier, it may be that in some circumstances, or jurisdictions, they are better performed by the credit aggregator, or vice versa. However, the general principle of the present invention is to separate the relationships so that a borrower does not directly contract with credit suppliers whilst retaining an ability for credit suppliers to recover funds if necessary from the borrower.

Of course, it will be recognised by those skilled in the art that the term “borrower” refers to an entity that has either received credit or is a potential recipient of credit depending upon the outcome of a credit risk assessment. Similarly, the term “credit aggregator” refers to an entity that aggregates credit or seeks to aggregate the various credit facilities of a single supplier or various credit facilities of a range of credit suppliers. Also, the term “credit supplier” refers to an entity that is either supplying credit or seeks to supply credit to potential borrowers. As previously stated, in the event that a credit supplier also acts as a credit aggregator, then the supplier will be considered to be either a credit supplier or a credit aggregator depending upon the capacity in which they are acting at any point in time.

In the preferred embodiment, the borrower may be assisted by an intermediary identified as an “adviser”. For each step in the process, the borrower and/or adviser can be considered to be acting for that particular step. Similarly, each entity described in the preferred embodiment may be considered to be acting for themselves or alternatively may have an intermediary acting on their behalf.

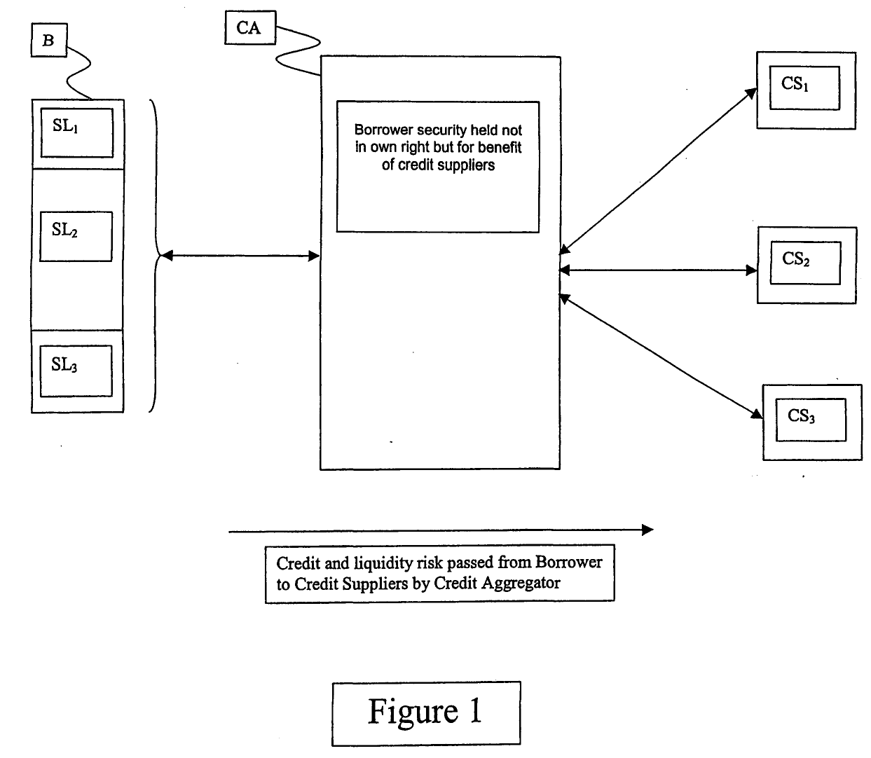

FIG. 1 illustrates a borrower (B) who has segmented their overall credit requirement into three segments. The individual credit offer for each segment had been previously agreed between the credit aggregator (CA) and three separate credit suppliers (CS₁, CS₂ and CS₃). The credit offer for each segment may be negotiated for the purpose of satisfying the credit requirements of the borrower or they may be in accordance with “standing” agreements established between the credit aggregator and individual credit suppliers.

The terms relating to each segment include a segment limit, namely, SL₁, SL₂ and SL₃ and the responsibility for supplying credit up to those limits rests with the corresponding credit suppliers as a result of the separate credit agreements between the credit aggregator and each credit supplier.

It is conceivable that the credit aggregator (CA) may have credit agreements with multiple borrowers with alternative segmentation with the credit for each segment sourced by the respective credit suppliers. In this case, there may only be a single agreement between each of CS₁, CS₂ and CS₃ and the credit aggregator (CA).

In a preferred embodiment, the agreements established between the borrower, credit aggregator and credit suppliers provide for the credit aggregator passing credit and liquidity risks associated with a segment element to the relevant credit supplier. Additionally, in the event of a default with respect to the terms and conditions of a credit agreement between the borrower and the credit aggregator, the credit suppliers are preferably appointed as agents of the credit aggregator in order to recover any debts from the borrower.

Credit suppliers will usually assess any security offered in respect of a credit arrangement. Where the security offered is an asset that may be valued according to established principles, this aspect of the method lends itself to being handled efficiently by communicating the details of the asset and the borrower to the credit suppliers for assessment.

It is generally accepted that there are three components of assessment with respect to assessing an application for credit. Firstly, the borrowing capacity of a borrower is assessed and this is usually based upon factors such as existing debts and cashflow. Secondly, the value of any security is usually assessed which includes factors such the propensity for the value of the asset to change over time. Thirdly, the credit risk of an individual borrower is usually assessed by a credit supplier in accordance with proprietary models established by individual credit suppliers.

In the preferred embodiment, the credit aggregator assesses the borrowing capacity of the borrower and the value of the asset in accordance with valuation techniques that are acceptable to the credit suppliers. Further, the credit suppliers assess the credit risk associated with the borrower according to their own models for assessing this type of risk. It is possible that this third component of the assessment could be performed by the credit aggregator but it would generally need to be in accordance with the credit risk assessment models of each respective credit supplier.

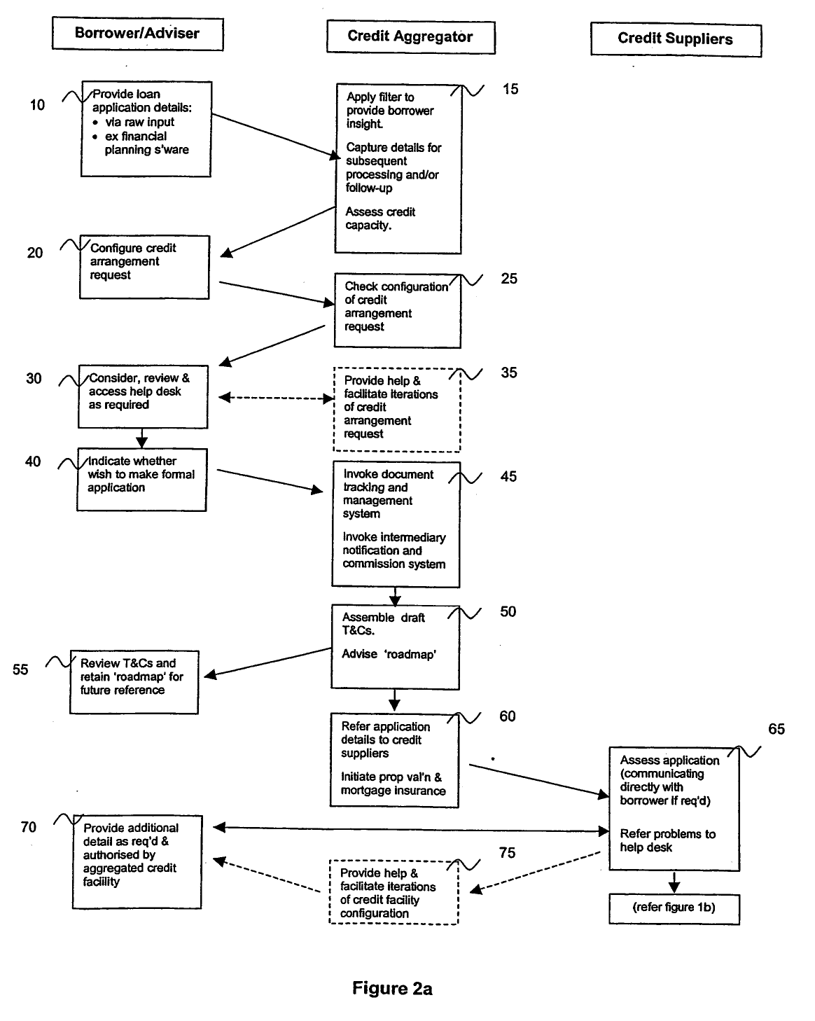

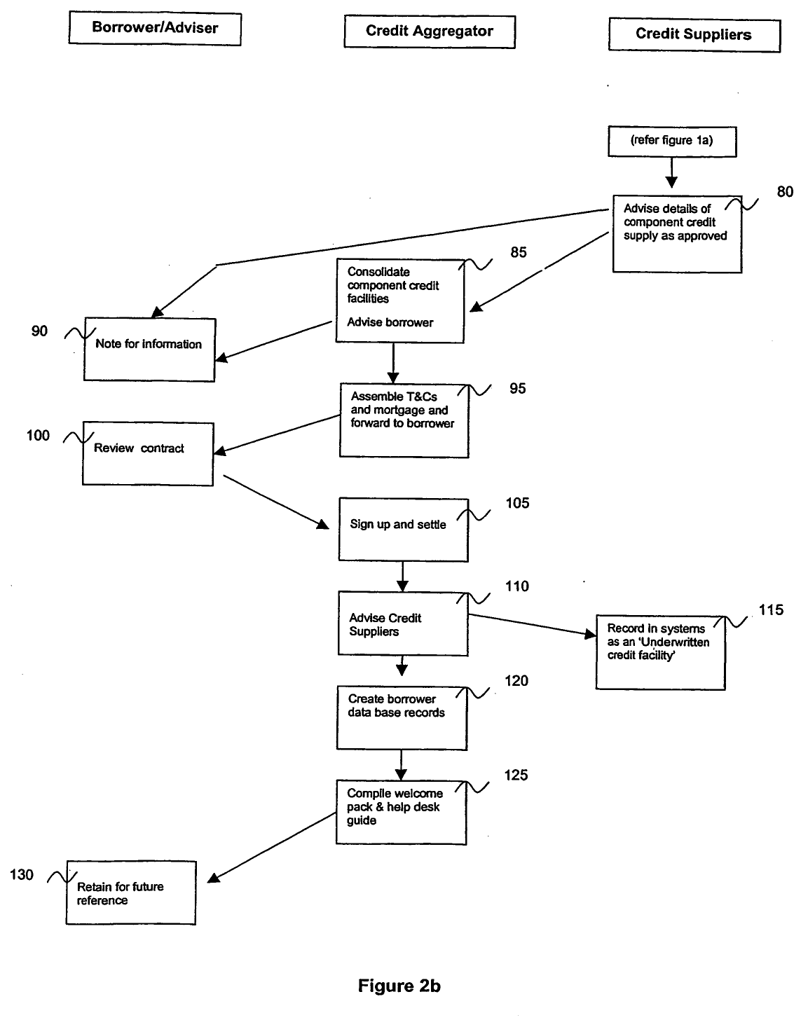

With reference to FIGS. 2a and 2b, a method of a borrower/adviser being provided with credit from a credit aggregator is illustrated. The process is initiated at step 10 by a borrower/adviser providing loan application details to a credit aggregator. The loan application details of the borrower/adviser may be obtained from an external database for forwarding to the credit aggregator or may be generated specifically for this task. Once forwarded, the credit aggregator receives those details at step 15 and captures those details for subsequent processing and/or follow-up. Additionally, at step 15, the credit aggregator assesses the credit capacity of the borrower using techniques acceptable to the credit suppliers. At this step, the credit aggregator may also conduct an analysis of the loan application details in order to generate a profile of the borrower for future reference. For example, factors such as the credit requirement and urgency for the credit may be considered indicative of the borrower's potential future behaviour. From the loan application details provided at step 10, step 15 should determine an indicative credit capacity based upon factors such as the borrower's income and current assets and liabilities. Assuming that basic requirements are satisfied in the loan application, the method progresses to step 20.

At step 20, the borrower/adviser is notified by the credit aggregator that their loan application details have been accepted. Accordingly, at step 20, the borrower/adviser is invited to configure a credit facility. At this step, it is expected that the borrower will research the credit options available from the credit aggregator by referring to the terms and conditions of credit suppliers represented by the credit aggregator.

In the preferred embodiment, the borrower/adviser has access to a computer system connected to a data communication network such as the Internet. Of course, alternative embodiments may use a private data communications network that securely retains records such that alternative credit suppliers cannot determine the offers of other credit suppliers. In any event, the use of such a system would facilitate the borrower/adviser researching the various terms and conditions offered by credit suppliers. The borrower/adviser analyses the various credit offerings to determine the best configuration that suits the borrower. This process may be assisted by various computer application programs in an attempt to configure an optimal credit supply for the borrower based upon pre-defined criteria.

Having configured a credit facility, the borrower/adviser transmits these details to the credit aggregator which are received at step 25.

At step 25, the credit aggregator checks the configuration of the borrower/adviser's credit arrangement to ensure that the requested arrangement falls within the borrower's credit limit and repayment capacity. In addition, the credit aggregator also checks that the requested credit arrangement satisfies the terms and conditions of the various credit suppliers. In checking the configuration of the credit arrangement, adjustments may be made to the requested arrangement and these are transmitted back to the borrower/adviser.

At step 30, the borrower/adviser receives from the credit aggregator an amended credit arrangement request which the borrower/adviser then considers. At this stage, the borrower/adviser may request help from the credit aggregator and may request details of various credit arrangements in view of any initial amendments made to the first credit arrangement request. This assistance is provided by the credit aggregator at step 35. Upon consideration and review of the credit arrangement request, the borrower/adviser indicates whether they wish to make a formal application at step 40.

In the instance that the borrower/adviser wishes to make a formal application, the credit aggregator initiates document tracking and management procedures in order to control the processing of the formal application. This is performed at step 45 in addition to initiating intermediary notification procedures in order to ensure that appropriate commissions are paid to any eligible commission recipients. At step 50, the credit aggregator generates a draft statement of terms and conditions incorporating the terms and conditions mutually agreed with the various credit suppliers and transmits the terms and conditions to the borrower/adviser for future reference. In addition, the credit aggregator may also provide detailed contact information of the borrower and a timetable for progressing the credit application of the borrower. Such information may be provided in the form of a credit application schedule.

At step 55, the borrower/adviser receives and reviews the draft statement of terms and conditions and any other detailed information provided by the credit aggregator.

Subsequent to generating a statement of draft terms and conditions at step 50, the credit aggregator refers the borrower application details to the relevant credit suppliers. This is performed at step 60 in addition to initiating an asset valuation request and/or a request for mortgage insurance if required.

Where the asset being provided as security for the credit arrangement is a domestic dwelling or residence, the asset may be valued according to established valuation techniques accepted by the credit suppliers.

The referred application is received by the credit suppliers at step 65 wherein the application is assessed according to proprietary techniques established by the individual credit suppliers. At this stage, credit suppliers may wish to communicate directly with the borrower. In addition, such an agreement is likely to prevent any credit supplier seeking information from a potential borrower other than that required for the purpose of assessing credit risk. Additionally, it is also expected that an established agreement would prevent any credit supplier acting to the detriment of any other credit supplier that supplies credit to the credit aggregator.

At step 65, credit suppliers affected by the credit arrangement request may initiate dialogue with the potential borrower wherein additional information is requested by a credit supplier. Any such request is received by the borrower/adviser at step 70 where the request for additional information is considered and supplied to the particular credit supplier. As part of this dialogue, the assistance of the credit aggregator may be sought which could be provided at step 75 in the form of calculating the effect of various credit arrangements. Of course, step 65 could occur earlier in the process thus providing credit suppliers with additional time in which to query the potential borrower.

Upon completing their assessment of the formal application, the credit suppliers at step 80 advise details of the component credit supply as approved. Preferably, these details are advised to the credit aggregator and the borrower/adviser substantially simultaneously. The details are received by the credit aggregator and the borrower/adviser at steps 85 and 90 respectively wherein the credit aggregator also advises the borrower.

At step 95, the credit aggregator assembles the various terms and conditions of the credit suppliers and generates an agreement reflecting those terms and conditions between the credit aggregator and the borrower.

At step 100, the borrower/adviser receives the agreement and upon execution, returns the agreement to the credit aggregator. At step 105, the agreement is executed and settled by the credit aggregator. Subsequently at step 110, the credit aggregator advises the relevant credit suppliers of the executed credit agreement who receive that advice at step 115. At step 120 the credit aggregator creates a borrower database record containing relevant information including date, transaction type, opening balance, transaction amount and closing balance. The database record is available to record subsequent information and maintain a history of transactions between the borrower/adviser and the credit aggregator. In particular, borrower database records may be used to determine the flow of funds between the credit aggregator, the credit suppliers and any intermediaries. At step 125, the credit aggregator compiles a welcome pack and helpdesk guide which are supplied to the borrower/adviser. Such information is received by the borrower/adviser at step 130.

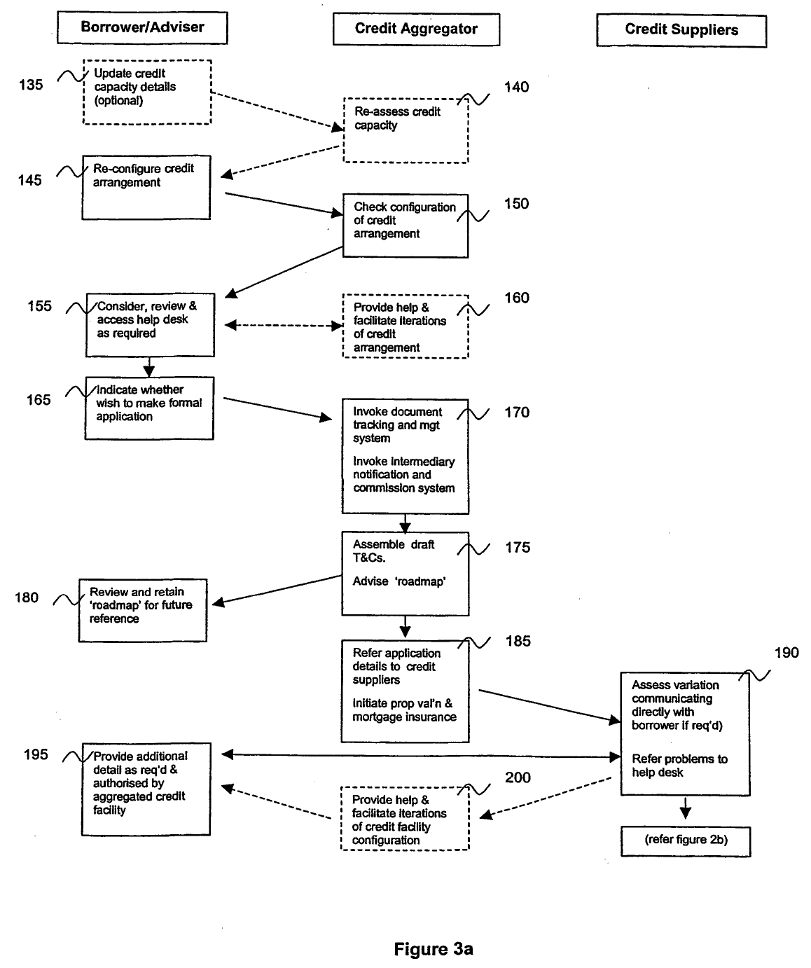

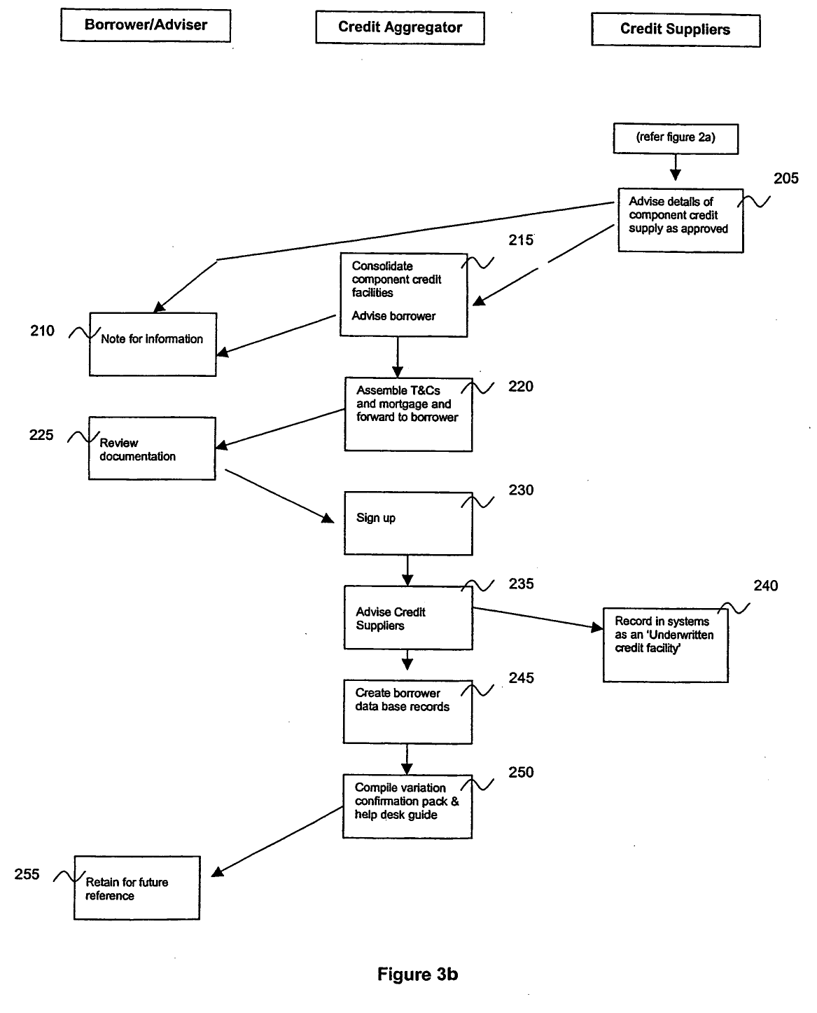

With reference to FIGS. 3a and 3b, the method steps for a borrower/adviser requesting a change to the credit agreement with the credit aggregator is illustrated. Of course, the credit requirements of a borrower/adviser are likely to change over time. Accordingly, a preferred embodiment of the method of the present invention includes steps enabling a borrower/adviser to request and effect a change to the credit agreement with the credit aggregator. In another embodiment, it is also possible for the credit aggregator and/or credit suppliers to assess the borrowing capacity of a borrower and spontaneously advise the borrower/adviser of the assessed credit capacity of the borrower.

In FIG. 3a, optional steps in the method are depicted in broken outline form. In particular, at step 135, a borrower/adviser is able to update their credit capacity details and supply those details to the credit aggregator. At step 140, the credit aggregator reassesses the credit capacity of the borrower/adviser and informs them of the reassessment.

At step 145, the borrower/adviser reconfigures their credit arrangement and transmits the details of that reconfiguration to the credit aggregator. Upon receipt of the reconfiguration details, at step 150 the credit aggregator edits the configuration of the credit arrangement and calculates the effect of such a reconfiguration in accordance with the present credit offers of the various credit suppliers. The credit aggregator then provides the details of the calculation of the reconfigured credit arrangement to the borrower/adviser.

At step 155, the borrower/adviser considers and reviews the effect of the reconfiguration request to their credit arrangement and may request further help from the credit aggregator as illustrated at step 160.

Upon considering and reviewing the reconfigured credit arrangement at step 165, the borrower/adviser indicates whether they wish to formally apply for a reconfigured credit arrangement. A formal request is received by the credit aggregator at step 170 wherein a document tracking and management procedure is initiated and procedures for the purpose of notifying intermediaries in order to ensure that the correct commission is calculated and provided to any eligible recipients. At step 175, the credit aggregator assembles a draft statement of terms and conditions and forwards the draft statement to the borrower/adviser. At step 180 the borrower/adviser reviews and retains the documentation received from the credit aggregator.

At step 185, the credit aggregator refers the formal application for a change to the credit arrangement to the various affected credit suppliers and initiates an asset valuation and mortgage insurance if required. At step 190, the relevant credit suppliers assess the formal request to vary the credit arrangement and enter into dialogue directly with the borrower/adviser if required. At this step, he assistance of the credit aggregator may be requested to assist the dialogue between the credit suppliers and the borrower/adviser. The dialogue with the borrower/adviser and any assistance provided by the credit aggregator are illustrated as steps 195 and 200 respectively.

With reference to FIG. 3b, the credit suppliers advise details of the component credit supply as approved at step 205. Preferably, these details are advised to the borrower/adviser and credit aggregator substantially simultaneously as illustrated at steps 210 and 215 respectively. Having received the details at step 215, the credit aggregator, at step 220, assembles the terms and conditions of the various credit suppliers and varies the credit agreement between the credit aggregator and the borrower/adviser reflecting those various terms and conditions in preparation for execution by the borrower/adviser.

The borrower/adviser reviews the variations at step 225 and upon execution returns the agreement to the credit aggregator at step 230. Upon the credit aggregator executing the agreement at 230, the credit aggregator then advises the various credit suppliers at step 235 wherein the credit suppliers record the details of the credit supply agreement in their various information systems at step 240.

At step 245, the credit aggregator creates a borrower database record reflecting the details of the variation to the credit agreement with the borrower/adviser. At step 250, the credit aggregator compiles details relating to the variation of the credit agreement between itself and the borrower/adviser and forwards those details to the borrower/adviser. The borrower/adviser receives those details at step 255 and retains those details for future reference.

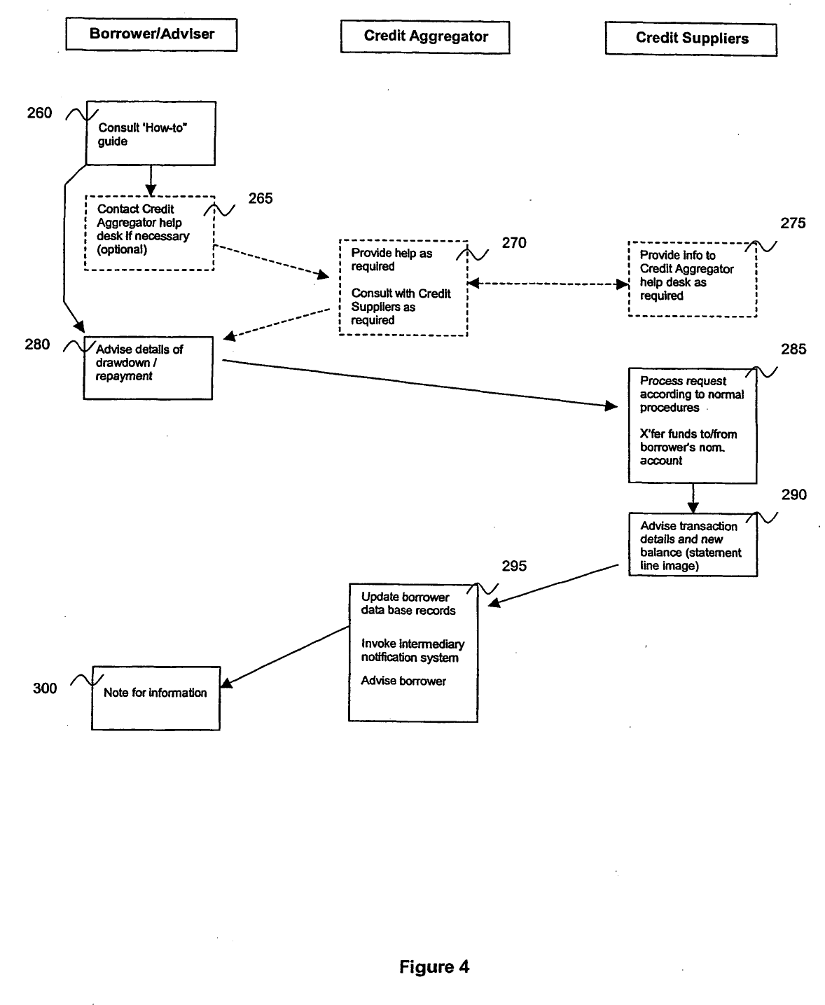

With reference to FIG. 4, the method steps for a borrower/adviser initiated drawdown and/or additional repayment of principal are illustrated. In particular, it is likely that a borrower/adviser will consult documentation in order to determine how to effect a drawdown and/or additional repayment of principal. This is illustrated at step 260 and in the event that the borrower/adviser requires further assistance they may contact the credit aggregator as depicted at step 265. In this instance, the credit aggregator will provide assistance as depicted at step 270 and may consult with credit suppliers, as depicted at step 275, in order to provide the assistance required.

At step 280, the borrower/adviser provides details of the drawdown/repayment they wish to effect. These details are advised directly to the credit suppliers who process the request and transfer funds to or from the customers nominated account at step 285. At step 290 the credit suppliers advise the transaction details to the credit aggregator and generate a new balance for the borrower/adviser.

In another embodiment, upon the borrower/adviser providing details to the credit aggregator of the drawdown/repayment they wish to effect, the credit aggregator processes the request and transfers funds directly to or from the borrower's nominated account. In this instance, the credit aggregator advises the transactions details to the credit suppliers.

In the present embodiment detailed in FIG. 4, upon receipt of the details of the drawdown/repayment, the credit aggregator at step 295 updates the borrower database records and initiates procedures in order to notify any intermediaries. At this step, the credit aggregator also advises the borrower/adviser of the details of the drawdown/repayment and the corresponding new balance. The customer/adviser receives this information at step 300.

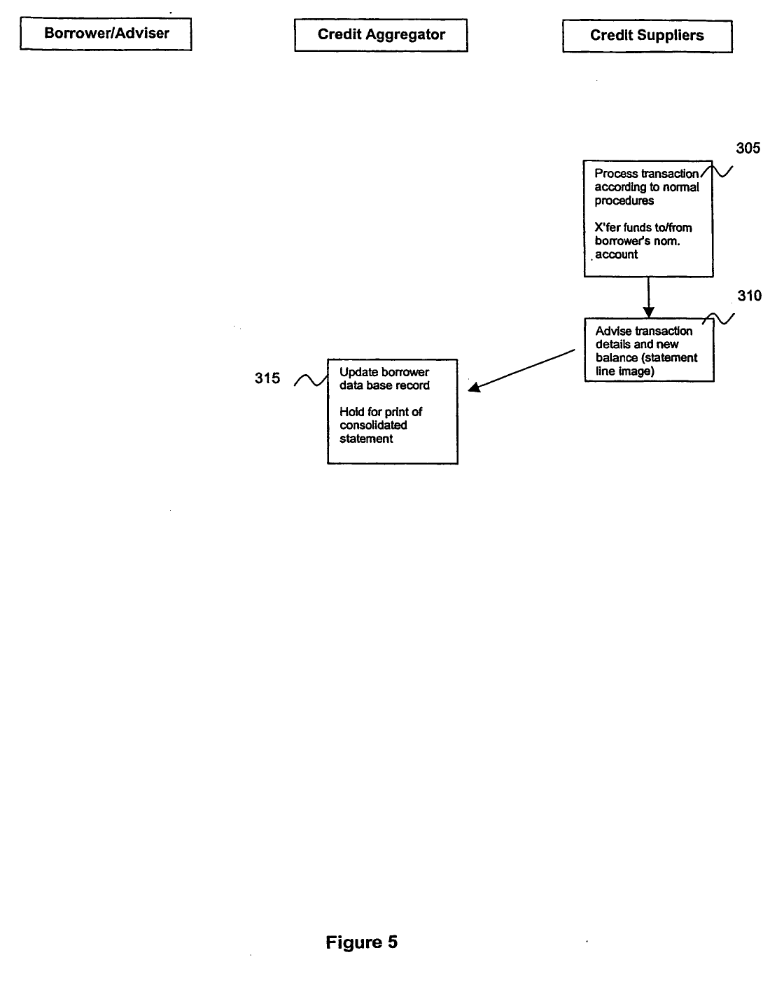

With reference to FIG. 5, a preferred embodiment of the method steps required for a scheduled principal repayment and/or interest charge levied upon a borrower/adviser are illustrated. Of course, the method steps illustrated are equally applicable to any other type of charge that may be levied by a credit supplier upon a borrower/adviser.

Generally, a schedule for the repayment of principal and/or interest charges in respect of credit are established at the time of obtaining credit from a credit supplier as part of the terms and conditions of the supply of that credit. In the present invention, it is expected that a schedule of principal repayments and/or interest charges will have been established for each and every credit supplier from whom credit is obtained. In a particularly preferred embodiment of the invention, at the time the credit aggregator enters into agreements with the various credit suppliers from whom credit will be obtained for the benefit of the borrower/adviser, an identical schedule for the repayment of principal and/or interest charges is established. As a result, a borrower/adviser is better able to manage their cash flow and is only required to monitor a single schedule of repayments for principal and/or interest charges.

At step 305, at a predefined time according to a previously established schedule for the repayment of principal and/or interest charges, credit suppliers process the scheduled repayment and/or interest charge and transfer funds from the borrower's nominated account.

In another embodiment, repayments of principal and/or interest charges are processed by the credit aggregator and funds for the scheduled repayment and/or interest charge are transferred from the borrower's nominated account by the credit aggregator. In this instance, the credit aggregator advises the credit supplier of the relevant transaction details.

In the embodiment detailed in FIG. 5, at step 310, the credit suppliers generate a new balance for the borrower/adviser and advise transaction details to the credit aggregator. The credit aggregator receives those details at step 315 and updates their borrower database record accordingly. At this step, the credit aggregator may retain the details of the transaction in order to produce a consolidated statement prior to advising the borrower/adviser.

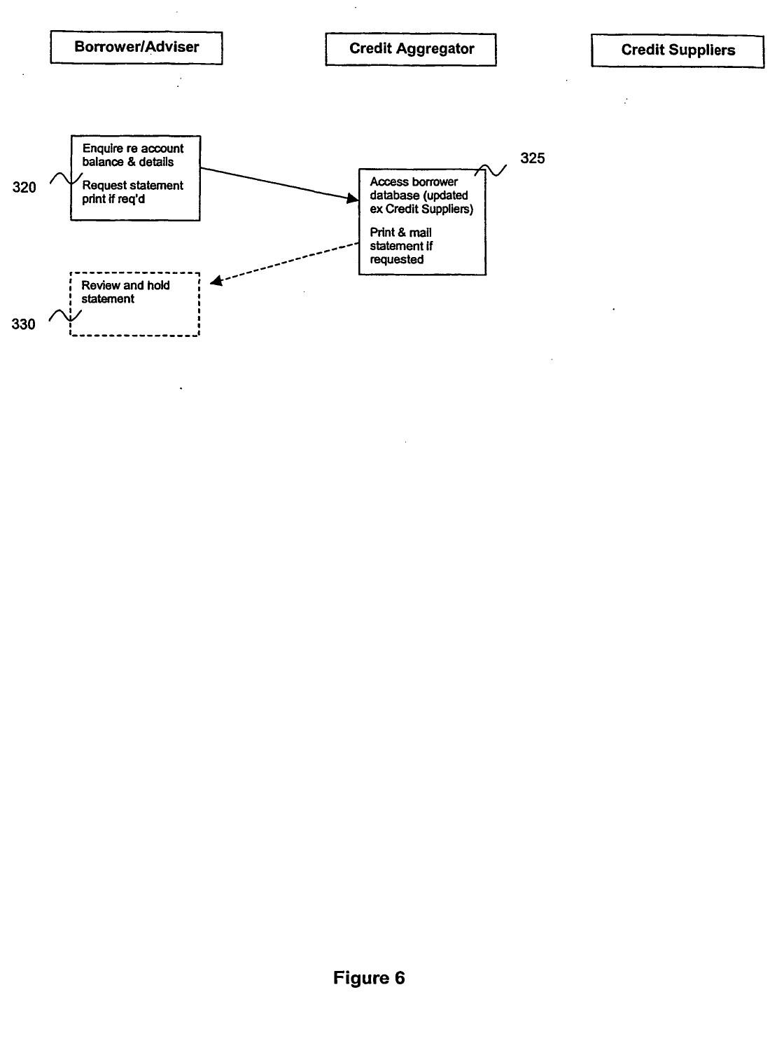

With reference to FIG. 6, a preferred embodiment of the method steps required for a borrower/adviser to obtain a statement of their transactions are illustrated. At step 320, the borrower/adviser initiates an inquiry regarding their account balance and details of transactions in relation to that account. In addition, the borrower/adviser may request a statement. At step 325 the credit aggregator receives the request from the borrower/adviser and accesses the borrower's database records in order to satisfy the inquiry. At step 325, the credit aggregator may print and mail the transaction statement to the borrower/adviser. In this instance, the borrower/adviser receives the printed statement at step 330.

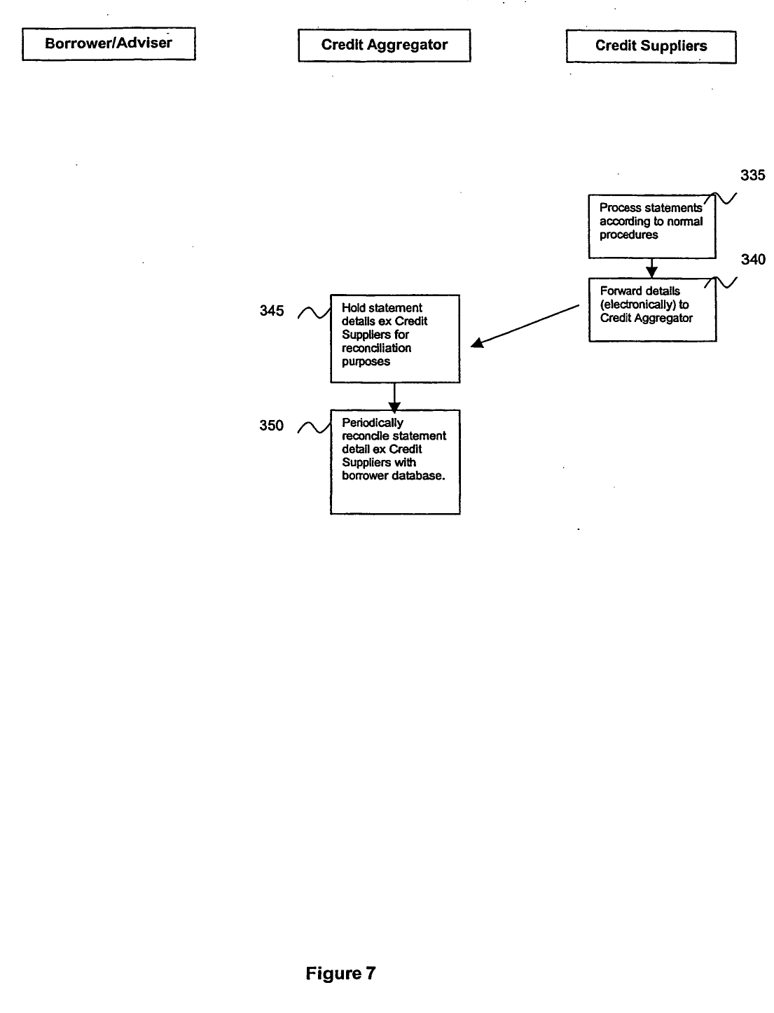

With reference to FIG. 7, a preferred embodiment of the method steps for a periodic reconciliation with credit suppliers is illustrated. In particular, at step 335, the credit suppliers process transaction statements according to their normal procedures. At step 340, the credit suppliers provide statements to the credit aggregator. In the preferred embodiment, these details are forwarded electronically from each credit supplier to the credit aggregator.

At step 345, the credit aggregator receives the details from the various credit suppliers and retains those statements as they arrive in preparation for conducting a reconciliation. At step 350, upon receipt of all relevant details from the various credit suppliers, the credit aggregator reconciles the various statements with the credit aggregators borrower database records.

In any arrangement involving the supply of credit, procedures must be established in anticipation of a default in respect of the terms and conditions of the supply of credit, said procedures being necessary to recover assets to the benefit of the credit supplier. In a preferred embodiment of the invention, the credit suppliers accept the risk with respect to the supply of credit to the borrower/adviser and effectively act as credit suppliers in respect of the credit agreement between the credit aggregator and the borrower/adviser.

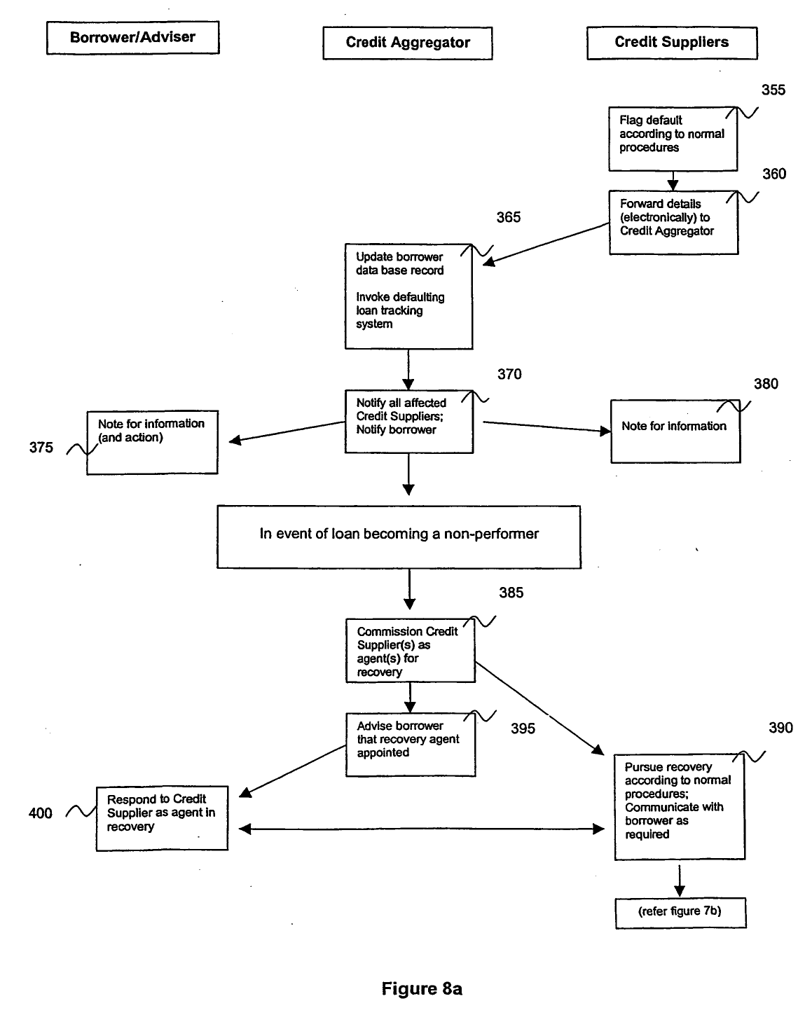

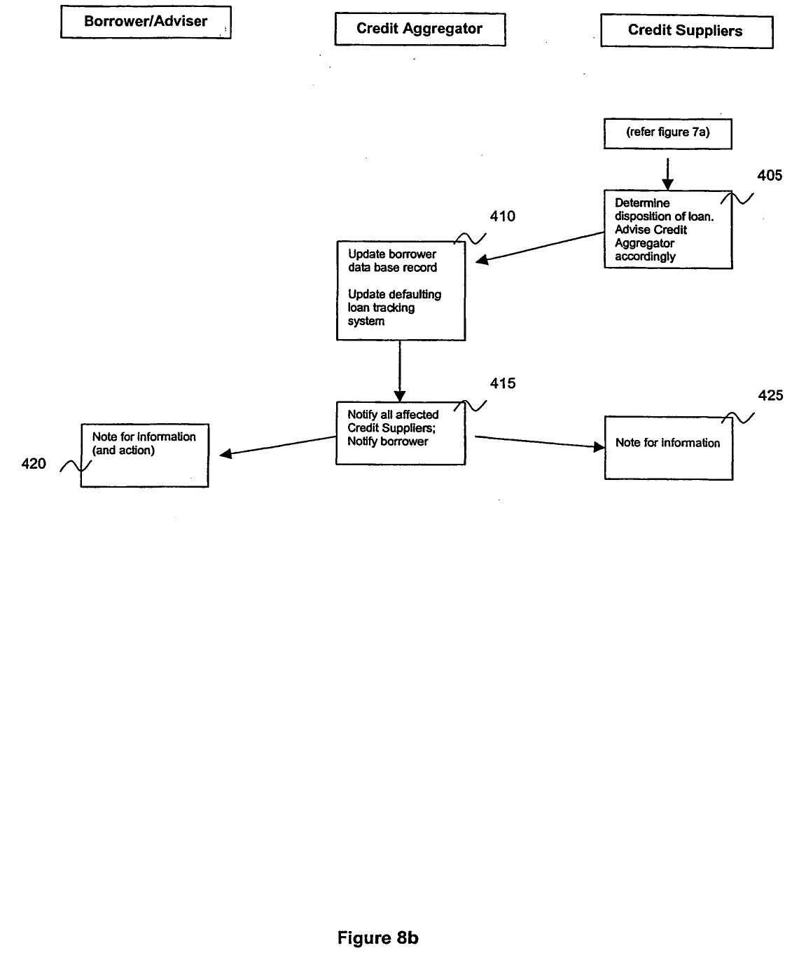

With reference to FIGS. 8a and 8b, a preferred embodiment of the method steps required for detecting a default and initiating recovery are depicted. In particular, at step 355, credit suppliers monitor the schedule of principal repayments and/or interest charges and identify any defaults according to those schedules.

In another embodiment, the credit aggregator monitors the schedule of repayments and/or interest charges and identifies defaults according to those schedules. In the event that a default is identified, the credit aggregator advises the relevant credit suppliers.

As detailed in FIG. 8a at step 360, when a default is detected the credit supplier forwards details of that default to the credit aggregator. At step 365, upon receipt of the details of a default, the credit aggregator updates their borrower database record and initiates default tracking procedures. In this instance, the credit aggregator notifies all affected credit suppliers in addition to notifying the borrower/adviser. The borrower/adviser and credit suppliers receive notification from the credit aggregator at steps 375 and 380 respectively.

Of course, there may have been a genuine mistake outside the control of the borrower/adviser that caused a default in relation to a repayment of principal and/or interest charges to a credit supplier. In this instance, it is expected that upon being notified of the default, a borrower/adviser would communicate with the credit aggregator and various credit suppliers in order to rectify the situation. In these circumstances, there would be no need to initiate a recovery process. However, in the event of a loan becoming non-performing, it would be necessary to initiate recovery action. In this instance, at step 385, the credit aggregator commissions one or more of the various credit suppliers as agent for the recovery of any outstanding debt. This action is communicated to credit suppliers who receive the advice at step 390 and initiate recovery action according to their established procedures.

In another embodiment, when a loan becomes non-performing, the credit aggregator initiates recovery action directly. In yet another embodiment, the credit supplier appoints a party other than a credit supplier as agent for the purpose of recovering any outstanding debt from a borrower.

In the present embodiment detailed in FIG. 8a, at step 395, the credit aggregator also advises the borrower/adviser of the appointment of a recovery agent. From this point, the borrower/adviser receives advice from the credit aggregator of the appointment of a recovery agent at step 400 and any further communication occurs directly between the borrower/adviser and the credit supplier(s) acting as recovery agent.

At step 405, the credit supplier(s) determines how best to settle any outstanding debt and advises the credit aggregator of the settlement details. Upon receipt of those details, the credit aggregator at step 410 updates their borrower database records and their default tracking system. At step 415, the credit aggregator notifies all affected credit suppliers and the borrower/adviser. The borrower/adviser and affected credit suppliers receive such notification at steps 420 and 425 respectively.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A method of providing credit to a borrower wherein a credit aggregator provides that credit to a borrower up to a first limit in accordance with at least one credit agreement between the borrower and the aggregator, the aggregator sourcing that credit in accordance with separate agreements between the aggregator and at least one credit supplier.

2. A method according to claim 1 wherein the at least one credit agreement solely consists of one or more agreements between the borrower and the aggregator and/or intermediaries acting for the borrower or aggregator.

3. A method according to claim 1 wherein the separate agreements solely consist of agreements between the aggregator and the at least one credit supplier and/or any intermediaries acting for the aggregator or credit supplier.

4. A method according to claim 1 wherein there is one credit agreement between the borrower and the credit aggregator for the purposes of providing credit to the borrower up to the first limit.

5. A method according to claim 1 wherein the first limit is segmented with each segment having a segment limit in accordance with terms agreed between the credit aggregator and individual credit suppliers from whom credit is provided.

6. A method of credit aggregation in an arrangement including a borrower, a plurality of credit suppliers, and a credit aggregator, the method including the steps of:
determining a borrower's credit requirements;
assessing offers of credit from the credit suppliers to determine a suitable combination of credit offers to meet the needs of the borrower;
the credit aggregator entering into at least one agreement with the borrower to provide the suitable combination of offers;
the credit aggregator entering into separate agreements with each of the credit suppliers in relation to the relevant parts of each offer to supply credit to the borrower;
wherein the arrangement of credit facilities are supplied by the credit suppliers to the borrower without the borrower entering into an agreement with the individual credit suppliers.

7. A method of credit aggregation in an arrangement including a borrower, a plurality of credit suppliers, and a credit aggregator, the method including the following steps in any order:
the credit aggregator entering into separate agreements with each of the credit suppliers for the supply of credit in accordance with offers of credit from the credit suppliers;
determining a borrower's credit requirements;
assessing offers of credit from the credit suppliers to determine a suitable combination of credit offers to meet the needs of the borrower;
the method subsequently including the following steps of:
the credit aggregator entering into at least one agreement with the borrower to provide the suitable combination of offers, the relevant part of the combination of offers being subject of the relevant separate agreement with a credit supplier;
wherein the arrangement of credit facilities are supplied by the credit suppliers to the borrower without the borrower entering into an agreement with the individual credit suppliers.

8. A method according to claims 1, 6 or 7 wherein for individual credit suppliers, the credit aggregator passes borrowers' payments to the credit supplier and provides credit from the credit supplier for the purpose of funding payments to the borrower.

9. A method according to claims 1, 6 or 7 wherein the credit aggregator holds any security provided by the borrower associated with securing credit not on its own account but for the benefit of the credit suppliers.

10. A method according to claim 9 wherein the security is not exclusive for any particular credit supplier.

11. A method according to claims 1, 6 or 7 wherein the credit agreement between the credit aggregator and the borrower includes any agreed terms between the credit aggregator and the at least one credit supplier in respect of credit provided by the at least one credit supplier.

12. A method according to claims 1, 6 or 7 wherein the credit aggregator may vary the credit agreement with a borrower without establishing a new credit agreement.

13. A method according to claim 12 wherein variations avoid the need for a new credit agreement and may include variations to the terms agreed between the credit aggregator and individual credit suppliers.

14. A method according to claims 1, 6 or 7 wherein variation of the terms for any individual credit agreement includes a variation to a credit limit relating to credit provided by a credit supplier.

15. A method according to claims 1, 6 or 7 wherein the credit aggregator establishes new agreements with new and/or existing credit suppliers and offers new credit arrangements to prospective or existing borrowers in accordance with terms associated with those new agreements.

16. A method according to claim 15 wherein upon offering a new credit arrangement to an existing borrower, the credit arrangement may be accepted by the borrower and the agreement between the borrower and the aggregator may be varied to reflect the terms and conditions of the new credit arrangement.

17. A method according to claims 1, 6 or 7 wherein the credit aggregator extracts a commission from the borrower and/or credit suppliers as payment for their services in managing and administering the individual agreements with credit suppliers and the credit agreement with the borrower.

18. A method according to claims 1, 6 or 7 wherein the credit aggregator charges a borrower a first interest rate and pays a credit supplier a second interest rate.

19. A method according to claims 1, 6 or 7 wherein the credit aggregator passes to individual credit suppliers the credit and liquidity risk associated with the respective credit limits of the credit suppliers in the at least one credit agreement between the borrower and the credit aggregator.

20. A method according to claims 1, 6 or 7 wherein the entity holding borrowers' collateral is a different entity as compared with that which establishes credit agreements with borrowers and credit suppliers.

21. A method according to claims 1, 6 or 7 wherein, in the event of default on the part of a borrower, the credit suppliers are appointed as agents of the credit aggregator in order to recover any outstanding debts from the borrower.

22. A method according to claims 1, 6 or 7 wherein, in the event of a default on the part of a borrower, the credit suppliers are empowered to enforce any security interests against the borrower.

23. A method according to claims 1, 6 or 7 wherein the credit aggregator may enter into multiple credit agreements with borrowers and may provide credit to those borrowers without entering into additional credit agreements with any individual credit suppliers.

24. A method according to claims 1, 6 or 7 wherein the credit aggregator and/or any one or more of the credit suppliers assesses the credit capacity of the borrower and advises the borrower of the outcome of the credit capacity assessment.

25. A method of credit aggregation in an arrangement including a borrower, a plurality of credit suppliers and a credit aggregator the method including the steps of:
determining a borrowers credit requirements;
providing the borrower with a plurality of credit offers enabling borrowers to segment their total credit requirement amongst offers;
the credit aggregator assessing the borrowers credit capacity and performing a valuation of any security proposed by the borrower, said valuation being in accordance with procedures acceptable to credit suppliers, and submitting a request to the relevant credit suppliers whose offers are included in the segments of the borrowers total credit requirement;
the relevant credit suppliers conducting a credit risk assessment of the borrower;
in the event that the relevant credit suppliers accept the borrowers request the credit aggregator enters into separate agreements with the relevant credit suppliers to provide credit to the borrower;
the credit aggregator assembling credit terms and conditions of relevant credit suppliers and establishing at least one credit agreement with the borrower;
wherein credit is provided to the borrower by the credit aggregator without the borrower entering into an agreement with the individual relevant credit suppliers and where the credit aggregator passes to the individual relevant credit suppliers the credit and liquidity risk associated with the respective credit limits of the credit suppliers and enabling borrowers the ability to reconfigure the segments of their credit arrangement without establishing a new agreement between the borrower and the credit aggregator.

26. A method according to claim 25 including the step of:
the credit aggregator receiving payments from a plurality of borrowers in accordance with established agreements and segregating between the credit aggregator and the borrowers, those payments according to the relevant credit suppliers and forwarding the payments due to the relevant credit suppliers in accordance with established agreements between the credit aggregator and the relevant credit suppliers.

27. A system for providing credit to a prospective borrower wherein a credit aggregator agrees terms with at least one credit supplier and offers credit to borrowers up to a first limit in accordance with those terms, the credit aggregator establishing at least one credit agreement with the borrower for the purpose of providing credit to the borrower and at least one credit supply agreement with the at least one credit supplier from whom credit is obtained, the system including:
a means for the credit aggregator and credit suppliers to agree terms relating to the supply of credit;
a means for a prospective borrower to provide details of their credit requirements to the credit aggregator;
a means for the credit aggregator to assist the prospective borrower select from a range of credit supply terms to suit their credit requirements, the resulting selection forming a credit segmentation satisfying the borrower's credit requirements;
a means for the credit aggregator to forward details of prospective borrowers to credit suppliers;
a means for the credit aggregator to administer cash flows relating to a borrowers' credit agreement with the credit aggregator and means for the credit aggregator to administer cash flows relating to credit supply agreements between the credit aggregator and the at least one credit supplier.

28. A system according to claim 27 wherein existing borrowers advise credit aggregators of changes to their circumstances affecting their credit requirements.

29. A system according to claim 27 wherein the borrower, credit aggregator and credit suppliers each operate a computing device that is operably connected to a data communications network.

30. A system according to claim 29 wherein the data communications network effects communication between the borrower, credit aggregator and credit suppliers for the transfer of information required for the establishment of at least one credit agreement between the borrower and the credit aggregator and at least one credit agreement between the credit aggregator and a credit supplier.

31. A system according to claim 29 wherein the data communications network includes the internet.

32. A system according to claim 27 wherein communication between the borrower, credit aggregator and credit suppliers occurs by electronic mail messages.

33. A system according to claim 27 wherein the credit aggregator and/or any one or more of the credit suppliers assesses the borrowers credit capacity and advises the borrower of the outcome of that assessment.

34. A system for credit aggregation in an arrangement including a borrower, a plurality of credit suppliers and a credit aggregator, the system including:
a data communication network and communication devices enabling communication between the borrower, credit aggregator and the plurality of credit suppliers;
a web-site enabling a borrower to segment their total credit requirements amongst various credit suppliers and to provide personal details and details of any security to a credit aggregator;
a first computing means operably connected to the data communications network to receive information from the web-site and operable to assess the borrowing capacity of the borrower and the value of the security offered by the borrower based upon information obtained from the web-site;
a second computing means operably connected to the data communications network to receive information from the web-site and other sources and operable to assess the credit risk of the borrower;
wherein, in the event that a borrowers request for credit is accepted, the credit aggregator enters into at least one credit agreement with the borrower and separate agreements with the credit suppliers where the credit aggregator passes to the individual credit suppliers the credit and liquidity risk associated with the credit provided by the credit suppliers.

35. In a data communications network including communication devices enabling communication between a borrower, a credit aggregator and at least one credit supplier, a method of providing credit to the borrower wherein the credit aggregator arranges the provision of credit to the borrower up to a first limit exchanging borrower and aggregator requirements over the communications network and establishing at least one credit agreement between the borrower and the aggregator, and by exchanging aggregator and supplier requirements over the data communications network and establishing at least one credit agreement between the aggregator and a credit supplier where the agreement between the borrower and aggregator is separate to the agreement between the aggregator and the at least one credit supplier.

36. A method according to claim 35 wherein the at least one credit agreement solely consists of one or more agreements between the borrower and the aggregator and/or intermediaries acting for the borrower or aggregator.

37. A method according to either claim 35 or 36 wherein the separate agreements solely consist of agreements between the aggregator and the at least one credit supplier and/or any intermediaries acting for the aggregator or credit supplier.

38. A method according to claim 35 wherein there is one credit agreement between the borrower and the credit aggregator for the purposes of providing credit to the borrower up to the first limit.

39. A method according to claim 35 wherein the first limit is segmented with each segment having a segment limit in accordance with terms agreed between the credit aggregator and individual credit suppliers from whom credit is provided.

40. In a data communications network including communication devices enabling communication between a borrower, a credit aggregator and at least one credit supplier, a method including the steps of:
the borrower providing details of their credit requirements over the communications network to credit aggregators;
credit suppliers providing details of available credit and supply terms to credit aggregators over the communications network;
the credit aggregator and borrower exchanging details of supply of credit with an acceptable combination of available credit from credit suppliers over the communications network and establishing at least one agreement between the borrower and the credit aggregator for supply of credit; and
the credit aggregator establishing separate agreements with each credit supplier with respect to the supply of the relative component of total credit supply to the borrower the separate agreements being established by exchanging details over the communications network
wherein the arrangement of credit facilities are supplied by the credit suppliers to the borrower without the borrower establishing an agreement with the individual credit suppliers.

41. A method according to claims 35 or 40 wherein for individual credit suppliers, the credit aggregator passes borrowers' payments to the credit supplier and provides credit from the credit supplier for the purpose of finding payments to the borrower.

42. A method according to claims 35 or 40 wherein the credit aggregator holds any security provided by the borrower associated with securing credit not on its own account but for the benefit of the credit suppliers.

43. A method according to claim 42 wherein the security is not exclusive for any particular credit supplier.

44. A method according to claims 35 or 40 wherein the credit agreement between the credit aggregator and the borrower includes any agreed terms between the credit aggregator and the at least one credit supplier in respect of credit provided by the at least one credit supplier.

45. A method according to claims 35 or 40 wherein the credit aggregator may vary, the credit agreement with a borrower without establishing a new credit agreement.

46. A method according to claim 45 wherein variations avoid the need for a new credit agreement and may include variations to the terms agreed between the credit aggregator and individual credit suppliers.

47. A method according to claims 35 or 40 wherein variation of the terms for any individual credit agreement includes a variation to a credit limit relating to credit provided by a credit supplier.

48. A method according to claims 35 or 40 wherein the credit aggregator establishes new agreements with new and/or existing credit suppliers and offers new credit arrangements to prospective or existing borrowers in accordance with terms associated with those new agreements.

49. A method according to claim 48 wherein upon offering a new credit arrangement to an existing borrower, the credit arrangement may be accepted by the borrower and the agreement between the borrower and the aggregator may be varied to reflect the terms and conditions of the new credit arrangement.

50. A method according to claims 35 or 40 wherein the credit aggregator extracts a commission from the borrower and/or credit suppliers as payment for their services in managing and administering the individual agreements with credit suppliers and the credit agreement with the borrower.

51. A method according to claims 35 or 40 wherein the credit aggregator passes to individual credit suppliers the credit and liquidity risk associated with the respective credit limits of the credit suppliers in the at least one credit agreement between the borrower and the credit aggregator.

52. A method according to claims 35 or 40 wherein the entity holding borrower's collateral is a different entity as compared with that which establishes credit agreements with borrowers and credit suppliers.

53. A method according to claims 35 or 40 wherein, in the event of default on the part of a borrower, the credit suppliers are appointed as agents of the credit aggregator in order to recover any outstanding debts from the borrower.

54. A method according to claims 35 or 40 wherein, in the event of a default on the part of a borrower, the credit suppliers are empowered to enforce any security interests against the borrower.

55. A method according to claims 35 or 40 wherein the credit aggregator may enter into multiple credit agreements with borrowers and may source credit to those borrowers without entering into additional credit agreements with any individual credit suppliers.

56. A method according to claims 35 or 40 wherein a credit aggregator agrees terms with at least one credit supplier and offers credit to borrowers up to a first limit in accordance with those terms, the credit aggregator establishing at least one credit agreement with the borrower for the purpose of providing credit to the borrower and at least one credit supply agreement with the at least one credit supplier from whom credit is obtained, a system including:
a means for the credit aggregator and credit suppliers to agree terms relating to the supply of credit;
a means for a prospective borrower to provide details of their credit requirements to the credit aggregator,
a means for the credit aggregator to assist the prospective borrower select from a
range of credit supply terms to suit their credit requirements, the resulting selection forming a credit segmentation satisfying the borrower's credit requirements;
a means for the credit aggregator to forward details of prospective borrowers to credit suppliers;
a means for the credit aggregator to administer cash flows relating to a borrowers' credit agreement with the credit aggregator and means for the credit aggregator to administer cash flows relating to credit supply agreements between the credit aggregator and the at least one credit supplier.

57. A method according to claims 35 or 40 wherein existing borrowers advise credit aggregators of changes to their circumstances affecting their credit requirements.

58. In a data communications network including communication devices enabling communication between a borrower, a credit aggregator and a plurality of credit suppliers, a method of credit aggregation including the steps of:
the borrower providing details of their credit requirements to credit aggregators over the data communication network;
the credit aggregator providing the borrower with details of a plurality of credit offers over the communications network said plurality of credit offers enabling borrowers to segment their total credit requirement amongst offers;
the credit aggregator assessing the borrowers credit capacity and performing a valuation of any security proposed by the borrower, said valuation being in accordance with procedures acceptable to credit suppliers and submitting a request over the communications network to relevant, credit suppliers whose offers are included in the segments of the borrowers total credit requirement;
the relevant credit suppliers conducting a credit risk assessment of the borrower;
in the event that the relevant credit suppliers accept the borrowers request, the credit aggregator establishes separate agreements over the communications network with the relevant credit suppliers to provide credit to the borrower;
the credit aggregator assembling credit terms and conditions of relevant credit suppliers and establishing at least one credit agreement with the borrower over the communications network
wherein credit is provided to the borrower by the credit aggregator without the borrower entering into an agreement with the individual relevant credit suppliers and where the credit aggregator passes to the individual relevant credit suppliers the credit and liquidity risk associated with the respective credit limits of the credit suppliers and enabling borrowers the ability to reconfigure the segments of their credit arrangement without establishing a new agreement between the borrower and the credit aggregator.

59. A method according to claim 58 wherein the data communications network effects communication between the borrower, credit aggregator and credit suppliers for the transfer of information required for the establishment of at least one credit agreement between the borrower and the credit aggregator and at least one credit agreement between the credit aggregator and a credit supplier.

60. A method according to claims 35, 40, or 58 wherein the communication devices comprise personal computers.

61. A method according to claims 35, 40, or 58 wherein the communication devices used by the borrower, credit aggregator and credit suppliers include any one or more of the following:
a laptop personal computer,
a notebook personal computer;
a wireless laptop personal computer;
a wireless notebook personal computer;
a cell phone; or
a cell phone having connection facilities for the internet.

62. A method according to claims 35, 40, or 58 wherein the data communications network comprises the internet.

63. A method according to claims 35, 40, or 58 wherein the exchange of information between the borrower, credit aggregator and credit suppliers is effected by a web-site.

64. A system for providing credit to a prospective borrower including a data communication network and communication devices enabling communication between a borrower, a credit aggregator and at least one credit supplier wherein a credit aggregator establishes terms with at least one credit supplier and offers credit to borrowers up to a first limit in accordance with the terms, the credit aggregator establishing at least one credit agreement with the borrower for the purpose of providing credit to the borrower and at least one credit supply agreement with the at least one credit supplier from whom credit is obtained, the system including:
personal communication devices enabling the credit aggregator and credit suppliers to exchange details and establish terms relating to the supply of credit;
a personal communication device enabling a prospective borrower to provide details of their credit requirements to the credit aggregator;
the personal communication device of the borrower and the credit aggregator operable to enable the credit aggregator to assist the prospective borrower select from a range of credit supply terms to suit the borrowers credit requirements, the resulting selection forming a credit segmentation satisfying the borrowers requirements;
the personal communication device of the credit aggregator operable to forward details of prospective borrowers to credit suppliers and to administer cash flow relating to a borrowers credit agreement with the credit aggregator and to administer cash flows relating to credit supply agreements between the aggregator and the at least one credit supplier.

65. A system according to claim 64 wherein communication between the borrower, credit aggregator and credit suppliers occurs by electronic mail messages.

66. A system according to claim 64 wherein the data communications network includes the internet.

67. A system according to claim 64 wherein communication between the borrower, credit aggregator and credit suppliers occurs by electronic mail messages.

68. A system according to claim 64 wherein the credit aggregator and/or any one or more of the credit suppliers assesses the borrower's credit capacity and advises the borrower of the outcome of that assessment.

69. A computer program product including computer useable medium having a computer readable program code embodied on said medium for effecting communication between a borrower, a credit aggregator and at least one credit supplier, said computer program product further including a computer readable code within said computer useable medium for:
enabling the borrower to provide details of their credit requirements to credit aggregators;
enabling credit suppliers to provide details of available credit and supply terms to credit aggregators;
enabling the credit aggregator and borrower to exchange details of supply of credit with an acceptable combination of available credit from credit suppliers and to establish at least one agreement between the borrower and the credit aggregator for supply of credit; and
enabling the credit aggregator to establish separate agreements with each credit supplier with respect to the supply of the relative component of total credit supply to the borrower
wherein the arrangement of credit facilities are supplied by the credit suppliers to the borrower without the borrower establishing an agreement with the individual credit suppliers.
